(19) United States
(12) Patent Application Publication
(10) Pub. No.: US 2019/0164229 A1
(43) Pub. Date: May 30, 2019

(54) A COMPUTER SYSTEM FOR DYNAMIC VEHICLE INSURANCE BILLING

(71) Applicant: OCTO TELEMATICS S.p.A., Rome (IT)

(72) Inventors: Fabio SBIANCHI, Rome (IT); Daniele TORTORA, Rome (IT); Claudia PROIA, Rome (IT); Maria FERRO, Rome (IT); Giovanni Antonio LIMA, Rome (IT); Pierpaolo PAOLINI, Rome (IT); Ernesto VIALE, Rome (IT)

(21) Appl. No.: 16/313,345

(22) PCT Filed: Jun. 30, 2017
(86) PCT No.: PCT/IB2017/053953

§ 371 Date: Dec. 26, 2018

(30) Foreign Application Priority Data
Jul. 1, 2016 (IT) 102016000068893

(51) Int. Cl. G06Q 40/08; G06Q 50/30; G06Q 30/02; G07C 5/00; B60W 40/09; G06K 9/00

(52) U.S. Cl. CPC G06Q 40/08; G06Q 50/30; G06K 9/00845; G07C 5/008; B60W 40/09; G06Q 30/0283

(57) ABSTRACT

A computer system is disclosed for dynamic vehicle insurance billing, comprising a data storage device storing instructions and a data processor that is configured to execute the instructions to cause the computer system to calculate risk values associated with one or more trips of a vehicle based at least in part on telematics data associated with the vehicle, and determine an insurance value based at least in part on the risk values.

### BACKGROUND

Existing insurance pricing systems often calculate insurance prices based on a static set of variables and/or information associated with a driver. And as insurance becomes more of a commodity within the policyholder market, insurance providers are often chosen according to price offering. Accurate ratemaking has therefore become more important than ever for the insurance company. A technique for billing insurance based on a driver's vehicle usage may be useful.

### SUMMARY

A computer system for dynamic vehicle insurance billing may include a data storage device storing instructions and a data processor that is configured to execute the instructions to cause the computer system to calculate risk values associated with one or more trips of a vehicle based at least in part on telematics data associated with the vehicle and to determine an insurance value based at least in part on the risk values.

Additional features, advantages, and embodiments of the invention are set forth or apparent from consideration of the following detailed description, drawings and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number indicate the drawing in which an element first appears.

FIG. 1 is a block diagram of a system to collect and process vehicle telematics data.

FIG. 2 is a diagram depicting a vehicle damage evaluation tool according to various embodiments.

FIG. 3 is a block diagram of a billing platform according to various embodiments.

### DESCRIPTION

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples.

Embodiments of the present invention relate to dynamically determining vehicle insurance costs based on vehicle telematics data. Embodiments of the present invention also relate to a platform configured to dynamically determine insurance costs based on vehicle telematics data. Telematics data collected from a vehicle (such as vehicle location data, vehicle speed data, vehicle dynamics, etc.) is used to determine a level of risk associated with the vehicle and/or its driver(s) (e.g., risk factors). An insurance value is determined based on the risk factors. The vehicle owner may then be billed based on the insurance value. In one example, a vehicle insurance policy holder may have a pre-paid account of insurance premium funds to spend over a period of time (e.g., a month, year, etc.), and an amount derived from the insurance value is deducted from the insurance premium funds. In another example, a vehicle insurance policy holder may be billed an insurance premium at the end of the month, quarter, year, etc. that is derived from the insurance value.

In some embodiments, vehicle telematics data is collected from a vehicle. The telematics data may include vehicle trip data such as location, speed, time, and/or other data for one or more trips. A vehicle trip may include a drive from point A to point B, a trip or a portion of trip along a particular road, and/or other path of travel. Telematics data may also include vehicle dynamics data, such as acceleration, deceleration, braking force, g-forces applied to various portions of the vehicle, and/or other data associated with the vehicle. Telematics data may also include or be used to derive context information associated with a vehicle trip, such as weather during the trip, road conditions, time of day, volume of traffic, and/or other information representing a context of the vehicle trip. The telematics data may be used to determine how much risk is associated with the vehicle and/or driver depending on how, when and where the driver drives and in which context. The risk may be quantified in one or more risk factors or risk values. For example, driving along a certain road known to have a high incidence of crashes may correlate to first risk value, a driving along another road known to have lower incidence of crashes may correlate to a second risk value. The first risk value may be larger than the second risk value. A risk value may represent a risk of exposure to vehicle damage and/or bodily harm to the vehicle occupants. A risk value be determined based on vehicle crash data associated with other vehicles and drivers on that road. Vehicle crash data may include a number of crashes, a severity of the crashes, estimated cost to repair or replace vehicles involved in the crashes, and/or known cost to replace or repair vehicles. A risk value may represent a likelihood of being in a vehicle crash and/or likely severity of the crash. Risk values may also be calculated and/or adjusted based on context information, such as weather, time of day, traffic, road conditions, etc. For example, driving in rainy conditions on a particular road may be associated with a larger risk value than driving on the same road in clear conditions. The risk values may be determined based on vehicle crash data associated with the context information. Similar approaches may be used to determine risk values associated with vehicle dynamics values, such as acceleration, deceleration, g-forces, etc.

In various embodiments, advanced analytical models can be used to determine relationships between various risk factors. Embodiments of the invention can include a Telematics service based on Big Telematics data which allows to rank each driver with respect to several driving style perspectives generated in a different context. Additionally, the driver may be ranked according to the crash information benchmarks of the driver's geographical driving patterns compared to the crash information of the driver population in those particular communities. Multivariate statistical techniques, such as Generalized Linear Modelling (GLM) together with machine learning approaches, may be used determine relationships between multiple risk factors. Similar to claim frequency predictive modelling, embodiments of the invention can make use of GLM modeling based on crash information.

A value of embodiments of the invention relies on Big Data assets, specifically taking into account driving habits, patterns, and behavior multivariate effects targeted with the probability to cause a crash event.

According to some embodiments, risk values are associated with and include potential claim costs. A potential claim cost may represent the likelihood, severity, and/or cost of incurring vehicle damage or bodily injury. The claim costs may be based on a variety of vehicle crash data. Vehicle crash data may include severity of the crashes for other vehicles, for example, on a given road, in a particular context, under certain vehicle dynamics conditions. Vehicle crash data may include analysis of crash dynamics reconstruction. Such dynamics reconstruction can be used to determine car impact area, such as front bumper, rear door, hood, entire vehicle, etc. And the impact area can be used to determine cost of spare parts and related labor hours needed to repair the vehicle, as stored in a database of previous claim information or a database storing costs for repairing particular makes and models of vehicles. Vehicle crash data may also include a potential damage estimation based on vehicle characteristics, such as impact strength measured as G-force or other dynamic measures (e.g., position, speed, acceleration before/after the crash event, etc.).

In various embodiments, risk values are calculated based on Big Data assets including estimated frequency (e.g., related to the probability to have a crash) and severity (e.g., related to potential cost of such crash) are derived for each trip representing the risk exposure and/or potential cost. The risk values are calculated for a specific context characterized by telematics data managed into a Big Data telematic ecosystem (e.g., type of road, type of day, time of the day, risky zone crossed, weather condition, traffic congestion, vehicle's information, etc.)

Risk values are used to determine insurance values for one or more trips. The insurance value may include a cost and/or premium to be paid for the trip. Depending on any combination of contexts and telematic parameters a potential cost of the single trip is determined. For example, the insurance value may be derived from the risk exposure, potential cost of vehicle damage, and/or data included in the risk values.

In various embodiments, a vehicle owner (policy holder) is charged an insurance premium or other insurance-related fee based on the insurance value. In one example, insurance values for multiple trips over a period of time are calculated, and a vehicle policy holder is charged an amount based on the insurance values. The charges may, for example, be deducted from the policy holder's account. Alternatively, the policy holder may be sent an invoice (such as an electronic invoice) including an insurance premium derived from the insurance value.

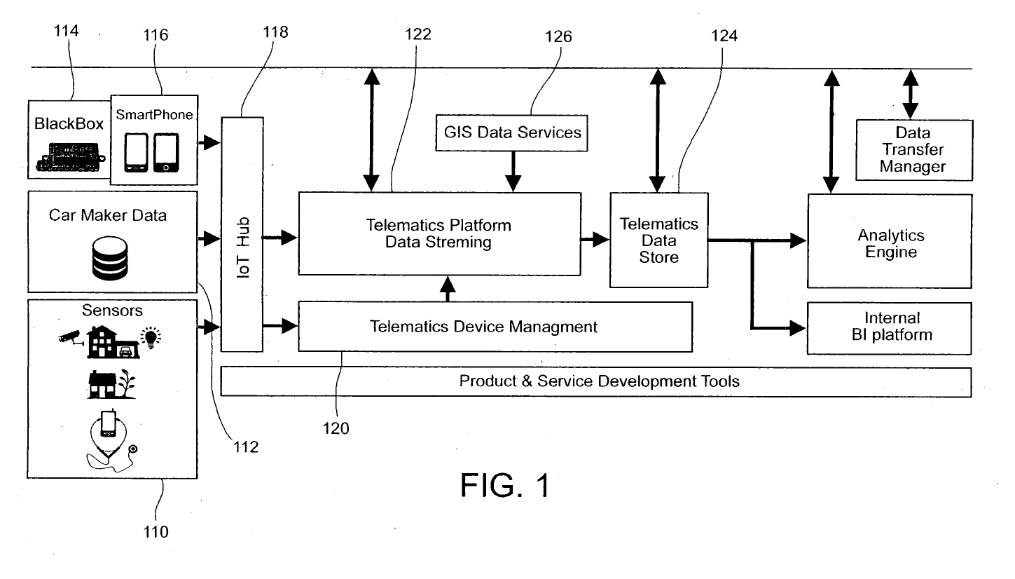

FIG. 1 is a block diagram of a system to collect and process vehicle telematics data. As can be seen from FIG. 1, sensors 110, car maker data 112, blackboxes 114, and/or smart phones 116 can be used to provide data for users and/or vehicles. These devices 110, 112, 114 and/or 116 can be configured to include computer components that are connectable to the Internet to enable them to be Internet of Things devices. These devices can be configured to communicate either hardwired or wirelessly with one or more Internet of Things hub stations 118. The hub station 118 may be of any type of device configured to interface with the Internet of Things devices and one or more communication networks.

Raw sensory data or readings may be interpreted with respect to physical environments, such as using situation/context-awareness, in order to provide semantics services. Some services may be time sensitive. For example, the actions for controlling physical environments may need to be performed over IoT devices in real-time fashion. A physical IoT device may provide multiple types of services or multiple IoT devices may collaborate or be grouped together to provide a service. This data can relate to accidents including severity, frequency and type of accident involved with a number of vehicles.

The data flow can proceed to a telematics device management module 120 that manages data coming from the IoT hub station 118. The data can also proceed to the telematics platform data streaming module 122. For traffic to and from a physical environment, physical IoT devices may generate data streams which may be event-driven, query-driven, or periodical in nature.

There may be an uncertainty in the readings or raw sensory data from physical IoT devices. Some IoT devices, such as distributed cameras, may generate high-speed data streams, while other IoT devices may generate extremely low data rate streams. The data flow generated from most IoT devices is real-time data flow, which may vary in different time scale. There may be anycast, multicast, broadcast, and convergecast traffic modes. Geographical Information Service Data Services module 126 can interface with the acquired data in the telematics platform data streaming module 122, which can provide contextual information, such as weather information, traffic data, road type, and/or other context information.

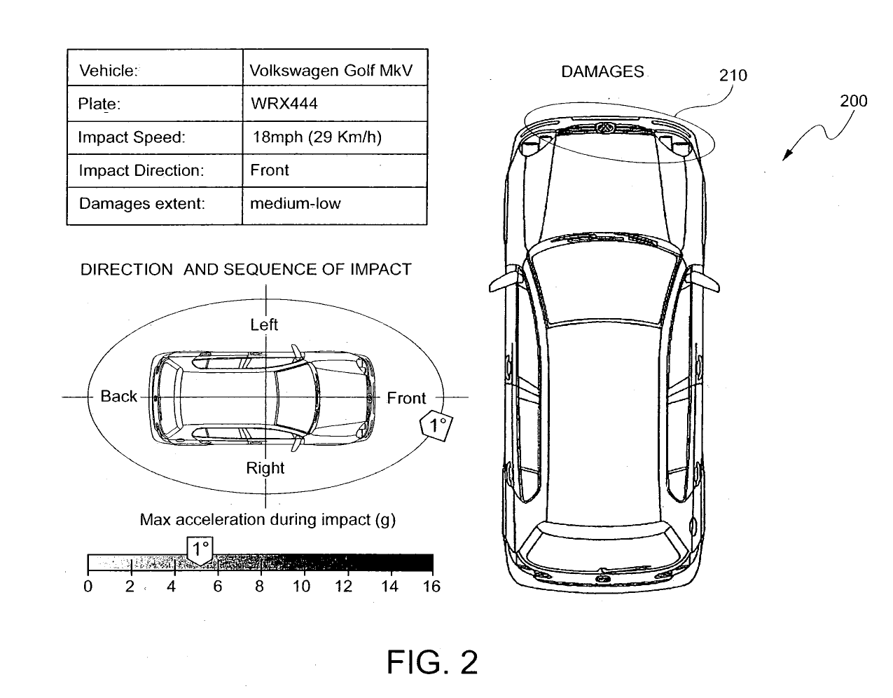

FIG. 2 is a diagram depicting a vehicle damage evaluation tool according to various embodiments. To calculate potential cost (e.g., a risk value) associated with driving on a particular road, in a particular context, and/or under certain conditions, it may useful to estimate the damage to other vehicles and injuries to other drivers under similar conditions. The platform disclosed herein may include a damage evaluation tool configured to generate an approximation of the repair costs of a vehicle based on the vehicle telematics data and/or other information.

In the example shown, a damage evaluation tool 200 may determine an area of vehicle deformation, an extent of vehicle damage, and/or other vehicle crash information. In certain cases, the damage evaluation tool 200 outputs a specific view of the vehicle model 210, illustrating the area affected by the deformation 210. The area affected by the deformation 210 may be determined based on a variety of variables including direction and sequence of impact, maximum acceleration during impact, impact speed, vehicle make and model, damage extent and/or other variables.

In various embodiments, a “theorem of the triangle” may be used to model the dynamics of a vehicle accident. Accident reconstruction models based on this theorem allow, starting from the analysis of the deformations of the vehicle to reconstruct the direction of the force of impact and the kinetic energy lost in the collision by the vehicle. To obtain these quantities it is possible to use some standard parameters that are well suited to the majority of cases or to obtain vehicle specific parameters by running crash tests on a similar vehicle.

In certain cases, a damage evaluation tool may use a reverse function to predict or estimate the damage of the vehicle, starting from the direction of impact, the energy transferred or dissipated during the collision, and/or other vehicle dynamics information. Energy transferred or dissipated during the collision may be derived from the acceleration detected during impact and various parameters in a model representing characteristics of the vehicle, such vehicle weight, vehicle dimensions, mechanical characteristics of vehicle components, and/or other vehicle characteristics. In certain cases, the accuracy of the results are increased by deducing specific parameters from crash tests carried out by qualified organizations (e.g., Euro NCAP), whose libraries are public and extended to a large number of car models.

In some embodiments, the area affected by deformation 210 and/or other vehicle crash information are used to determine an extent of the damage resulting from the vehicle crash. And the extent of damage is used to determine or estimate the cost to repair the vehicle and/or cost of medical care for the vehicle occupants. The cost of repair may include and/or be derived from one or more parts included in the area of damage. The cost of repair may, for example, be determined based on the cost of spare parts and/or labor to repair the portions of the vehicle in the damaged zone. The cost of repair and/or medical costs are included in a risk value associated with one or more of the road on which the accident occurred, the context of the accident, and/or vehicle dynamics associated with the accident. And the risk value is used to calculate insurance values for other vehicles driving under similar circumstances.

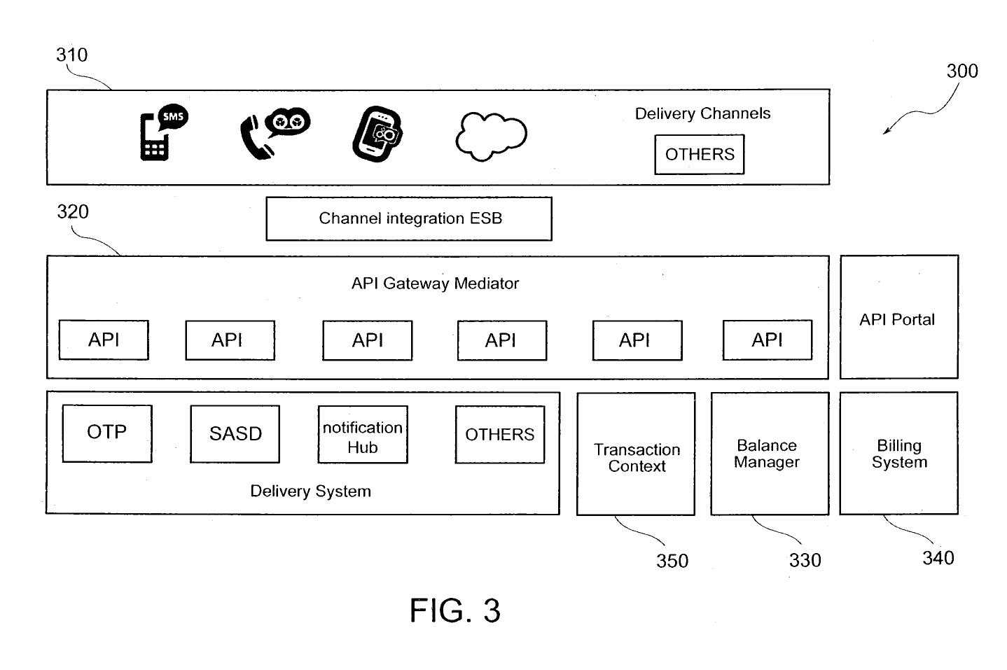

FIG. 3 is a block diagram of a billing platform according to various embodiments. A policy holder may interface with the billing platform 300 via a delivery channel 310, such as an application, text messaging interface, web portal, interactive voice response (IVR) interface, etc. An application programming interface (API) Gateway 320 mediates communication through the delivery channels 310 (e.g. IVR, Web Portal, SMS, APP, etc). The delivery channels 310 are exposed on API Gateway 320, which applies different types of policy enforcement, such as user authentication, throughput control, dynamic authorization (e.g., based on credit check). A Balance Manager 330 coordinates billing. Service transactions performed through the APIs are traced and real-time billed according to, for example, a service billing catalog configuration. The billing may also include insurance premium payments, once-off fees, service setup fees, etc. A billing system 340 may calculate the insurance values and/or insurance premium charges as discussed herein. The billing system 340 may communicate with the policy holder via the API Gateway 320 and delivery channels 310.

A transaction context 340 may be provided to manage complex transactions. For example, a service transaction may be complex depending on the service design. If the delivery process of a single service transaction is complex (e.g., it involves 2 or more applications), it may be necessary to keep track of all steps. A delivery context view may be generated to verify that all steps completed have been completed successfully and then finally debit the transaction to the account balance. The transaction context 340 builds the context as the service is being delivered and then notify the balance manager 330 upon the successful delivery.

In various embodiments, the billing platform 300 facilitates estimation and billing of insurance premiums based on a potential insurance cost of a single trip. The estimation of a potential insurance cost may be used as enabler of telematic products based on a real pay-per-trip system. In a pay-per-trip system, a driver may be pre-charged an amount, for example, at the beginning of a month, year, etc. Assuming, for example, that the driver is charged an upfront cost of 1,000 € and the driver chooses to drive from city A to city B, this trip will be concretized crossing different contexts with a different risk exposure and such trip will have expected cost that will be deducted from the upfront amount. When the account reaches zero or approaches zero the driver may be notified via the billing platform 300. The policy holder may refill their account at any time with any amount.

In a second example, a policy holder may manage their insurance premium bill by selecting specific contexts in which they intend to drive. In this system, a policy holder can decide how and in which way to manage its own (insurance) price based on the information related to single trips that characterize specific risk profiles. Other billing frameworks are of course contemplated within the scope of the present invention.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

1. A computer system for dynamic vehicle insurance billing, comprising:
a data storage device storing instructions;
a data processor that is configured to execute the instructions to cause the computer system to:
calculate risk values associated with one or more trips of a vehicle based at least in part on telematics data associated with the vehicle; and
determine an insurance value based at least in part on the risk values.

2. Computer system according to claim 1, wherein said telematics data associated with the vehicle include at least one of:
vehicle trip data comprising at least one of location, speed, time for one or more trips,
vehicle dynamics comprising at least one of acceleration, deceleration, braking force, g-forces applied to various portions of the vehicle, and
context information associated with a vehicle trip, comprising at least one of weather during the trip, road conditions, time of day, volume of traffic.

3. Computer system according to claim 1, wherein the data processor is configured to execute the instructions to cause the computer system to calculate risk values associated with one or more trips of a vehicle based on vehicle crash data associated with other vehicles and drivers, said vehicle crash data including at least one of a number of crashes, a severity of the crashes, potential damage estimation based on vehicle characteristics, estimated cost to repair or replace vehicles involved in the crashes, known cost to replace or repair vehicles, car impact area determined through analysis of crash dynamics reconstruction.

4. Computer system according to claim 3, wherein a cost of spare parts and related labor hours needed to repair the vehicle are based on the impact area and stored in a database of previous claim information or a database storing costs for repairing particular makes and models of vehicles.

5. Computer system according to claim 1, comprising a telematics device management module arranged to manage data coming from at least one Internet of Things hub station adapted to communicate with Internet of Things devices comprising at least one of sensors car maker databases (112), blackboxes and smart phones.

6. Computer system according to claim 1, comprising a telematics platform data streaming module arranged for managing data streams from physical Internet of Things devices which may be event-driven, query-driven, or periodical in nature.

7. Computer system according to claim 1, comprising a Geographical Information Service Data Services module arranged for interfacing with the telematics platform data streaming module for providing contextual information including at least one of weather information, traffic data, road type.

8. Computer system according to claim 1, comprising a damage evaluation tool arranged for determining at least one of an area of vehicle deformation and an extent of vehicle damage, based on variables including at least one of direction and sequence of impact, maximum acceleration during impact, impact speed, the energy transferred or dissipated during the collision, vehicle make and model, damage extent, wherein the energy transferred or dissipated during the collision is derived from the acceleration detected during impact and a plurality of parameters of a predetermined model representing the characteristics of the vehicle, including vehicle weight, vehicle dimensions, mechanical characteristics of vehicle components.
